(19) United States
(12) Patent Application Publication
(10) Pub. No.: US 2019/0021311 A1
(43) Pub. Date: Jan. 24, 2019

(54) AQUEOUS DISPERSIONS COMPRISING ACLONIFEN AND FLUFENACET

(71) Applicant: BAYER CROPSCIENCE AKTIENGESELLSCHAFT, Monheim am Rhein (DE)

(72) Inventors: Jens KRAUSE, Leverkusen (DE); Roland DECKWER, Frankfurt (DE)

(21) Appl. No.: 16/070,250

(22) PCT Filed: Jan. 9, 2017
(86) PCT No.: PCT/EP2017/050313

§ 371 Date: Jul. 13, 2018

(30) Foreign Application Priority Data
Jan. 15, 2016 (EP) 16151491.4

(51) Int. Cl. A01N 25/04; A01N 43/82; A01N 39/00

(52) U.S. Cl. CPC A01N 25/04; A01N 39/00; A01N 43/82

(57) ABSTRACT

The present invention relates to formulations in the form of aqueous dispersions comprising aclonifen and flufenacet and a mixture of anionic surfactants from the group of the naphthalenesulphonates or from the group of the condensates of naphthalenesulphonates with formaldehyde, nonionic surfactants from the group of the di- and tri-block-copolymers of alkylene oxides, and a specific mixture of organic and inorganic thickeners, to which further agrochemically active compounds and further customary auxiliaries and additives may optionally be added.

The aqueous dispersions have high storage stability and are suitable for use in the field of crop protection.

The present invention relates to the field of crop protection composition formulations. In particular, the invention relates to formulations in the form of aqueous dispersions which comprise the herbicidally active compounds aclonifen and flufenacet and which, after replacement of tristyrenephenol ethoxylates in the formulations, are storage-stable.

Herbicidally active compounds are generally not used in their pure form. Depending on the field of application and the type of application, and also on physical, chemical and biological parameters, the active compounds are used in a mixture with customary auxiliaries and additives as active compound formulation. The combinations with other active compounds for extending the spectrum of action and/or for protecting crop plants (e.g. by safeners, antidotes) are also known.

Formulations of herbicidally active compounds should generally have high chemical and physical stability, good applicability and user friendliness and a broad biological effect with high selectivity.

Aqueous dispersions for herbicidally active compounds, which also include aqueous suspension concentrates (SC), are known, inter alia from EP-A-0514768 (U.S. Pat. No. 5,707,926), EP-A-0592880 (U.S. Pat. No. 5,376,621) or WO 2007/112834 A2, which discloses formulations for flurtamone and diflufenican mixtures.

The herbicidally active compounds aclonifen and flufenacet are employed on their own and as a mixture (tank mix), inter alia as aqueous suspension concentrates (SC), for example with the trade names Bandur 600 SC (aclonifen) and Cadou 508 SC (flufenacet). In addition, it is also possible to add other mixing partners such as, for example, Brodal 500 SC (diflufenican). A frequent disadvantage of the individual formulations on which these and similar products are based is their lower biological activity compared to so-called coformulations (syn.: combination formulation, ready-to-use mixtures), where a plurality of active compounds are combined in a fixed mixing ratio in a formulation.

However, in the case of highly charged coformulations comprising several active compounds, the stability requirements of each individual active compound, which, depending on the active compound, may vary widely, have to be taken into account. In particular cases, interactions may also be observed, for example decomposition of an active compound owing to the direct presence of another. Another particular problem is the instability of formulations during storage, which reduces the shelf-life. Storage instability is identifiable, for example, by formation of a sediment (frequently owing to crystal growth of an active compound), which not only greatly reduces the biological activity of the individual active compounds but also leads to uneven distribution during outdoor application. This results inter alia, in addition to areas with overdosage, where crop plant damage occurs, also in areas with underdosage, where the unwanted growth of the harmful plants is no longer sufficiently controlled. In addition, underdosage may also lead to active compound-resistent harmful plants in subsequent years. An example which may be mentioned here is black-grass (Alopecurus myosuroides, ALOMY) whose difficult control inter alia in cereals represents a big problem.

A specific disadvantage of the above-mentioned aclonifen SC formulations is the fact that these comprise surfactants from the group of the tristyrenephenol ethoxylates (TSP-EO), which have delayed biological degradability. In addition, TSP-EO contains free phenol as an unwanted minor component, as a consequence of which this group of compounds has now been included in the REACH substitution list (European Chemicals Regulation REACH: Registration, Evaluation, Authorisation and Restriction of Chemicals)

During attempts to produce SC coformulations of the active compound mixture aclonifen and flufenacet, there were, caused by TSP-EO-comprising aclonifen SC formulations, unwanted effects. Addition of flufenacet resulted in a large sediment, which showed that formulations cannot be produced on this basis owing to a lack of the required storage stability.

It was an object of the present invention to provide aqueous crop protection agent formulations which comprise the active compounds aclonifen and flufenacet, are free from tristyrenephenol ethoxylates (TSP-EO), have sufficient biological activity and sufficient storage stability, without any negative effects such as flocculations, sedimentations, agglomerations and crystal growth occurring.

This object is achieved by aqueous dispersions comprising the active compounds aclonifen and flufenacet and a mixture consisting of anionic surfactants from the group of the naphthalene sulphonates or from the group of the condensates of naphthalene sulphonates with formaldehyde, nonionic surfactants from the group of the di- and tri-block-copolymers of alkylene oxides as replacement for tristyrenephenol ethoxylates (TSP-EO), a specific thickener mixture of at least one organic thickener based on xanthan gum and at least one inorganic thickener, preferably based on a synthetic thickener from the series of the silicic acids, further agrochemically active compounds, preferably diflufenican, to which optionally other customary auxiliaries and additives may be added.

Thus, the present invention relates to aqueous dispersions comprising

a) the herbicidally active compounds aclonifen and flufenacet,

b) one or more anionic surfactants from the group of the sulphonates, selected from the groups based on naphthalenes, the alkylaryl, the fused naphthalenes and based on lignin,

c) one or more nonionic surfactants from the group of the di- and tri-block-copolymers of alkylene oxides,

d) an organic thickener based on xanthan gum,

e) an inorganic thickener,

f) optionally one or more agrochemically active compounds different from component a), preferably the herbicidally active compound diflufenican,

g) optionally one or more further customary auxiliaries and additives,

and

water;

where the components d) and e) are in specific mixing ratios to one another.

The dispersions according to the invention exhibit excellent storage stability. At room temperature, they are storage-stable for at least 2 years, and they do not show any unwanted effects such as crystal growth during this time.

In a preferred embodiment, these dispersions comprise

a) 20 to 45% aclonifen and 4 to 20% flufenacet, at a total amount of 24 to 65%,

b) 0.3 to 3% of one or more anionic surfactants from the group of the sulphonates, selected from the groups based on naphthalenes, the alkylaryl, the fused naphthalenes and based on lignin,

c) 2 to 15% of one or more nonionic surfactants from the group of the di- and tri-block-copolymers of alkylene oxides,

d) 0.01 to 1% of an organic thickener based on xanthan gum,

e) 0.1 to 3% of an inorganic thickener,

f) 0 to 50% of one or more agrochemically active compounds different from component a), preferably 1 to 12% diflufenican,

g) 0 to 20% of one or more further customary auxiliaries and additives,

and

20 to 70% water;

where the components d) and e) are present in a ratio of from 1:300 to 10:1 to one another.

A particularly preferred embodiment are dispersions according to the invention which comprise

a) 20 to 45% aclonifen and 4 to 20% flufenacet,

b) 0.3 to 3% of one or more anionic surfactants from the group of the naphthalene sulphonates, alkylarylsulphonates or lignosulfonates, and from the group of the condensates of naphthalenesulphonates with formaldehyde,

c) 2 to 10% of one or more nonionic surfactants from the group of the di- and tri-block-copolymers of alkylene oxides,

d) 0.05 to 0.5% of an organic thickener based on xanthan gum,

e) 0.3 to 1.5% of an inorganic thickener,

f) 0 to 50% of one or more agrochemically active compounds different from component a), preferably 1 to 12% diflufenican,

g) 0 to 20% of one or more further customary auxiliaries and additives,

and

20 to 70% water;

where the components d) and e) are present in a ratio of from 1:30 to 2:1-1.5 to one another.

A very particularly preferred embodiment are dispersions according to the invention which comprise

a) 24 to 39% aclonifen and 6 to 14% flufenacet,

b) 0.4 to 2.5% of one or more anionic surfactants from the group of the naphthalene sulphonates, alkylarylsulphonates or lignosulfonates, and from the group of the condensates of naphthalenesulphonates with formaldehyde,

c) 2.5 to 8% of one or more nonionic surfactants from the group of the di- and tri-block-copolymers of alkylene oxides,

d) 0.1 to 0.3% of an organic thickener based on xanthan gum,

e) 0.4 to 1.3% of an inorganic thickener,

f) 0 to 50% of one or more agrochemically active compounds different from component a), preferably 2 to 10% diflufenican,

g) 0 to 20% of one or more further customary auxiliaries and additives,

and

25 to 70% water;

where the components d) and e) are present in a ratio of from 1:15 to 1:1 to one another.

Here and in the entire description, all percentages are percent by weight (% by weight) and refer, unless defined otherwise, to the relative weight of the respective component based on the total weight of the formulation.

The herbicidally active compounds (components a) aclonifen (10) and flufenacet (397) as individual substances or as mixtures are known, for example, from “The Pesticide Manual”, 16th edition (2012), The British Crop Protection Council (note: index number in brackets).

The proportion of these active compounds in the dispersions according to the invention (component a) can be 0.1-50% by weight, preferably 20-45% by weight, particularly preferably 24-39% by weight for aclonifen and 0.1-50% by weight, preferably 4-20% by weight, particularly preferably 6-14% by weight for flufenacet.

Proportionally, the total amount of the two active compounds can be 24-65% by weight, preferably 25 -55% by weight, particularly preferably 30-50% by weight.

Examples of anionic surfactants (components b) from the group of the naphthalenesulphonates are Galoryl® MT 800 (sodium dibutylnaphthalenesulphonate), Morwet® IP (diisopropylnaphthalenesulphonate) and Nekal® BX (alkylnaphthalenesulphonate). Examples of anionic surfactants b) from the group of the condensates of naphthalenesulphonates with formaldehyde are Galoryl® DT 201 (naphthalenesulphonic acid hydroxy polymer with formaldehyde and methylphenol sodium salt), Galoryl® DT 250 (condensate of phenol- and naphthalenesulphonates), Reserve® C (condensate of phenol- and naphthalenesulphonates), Morwet® D-425 (Akzo-Nobel) and also Tersperse® D-2020 (Huntsman) as respective naphthalenesulphonate/formaldehyde condensate. Preference is given to unsubstituted naphthalenesulphonate/formaldehyde condensates such as, for example, the products Morwet® D-425. Examples on lignin base are, for example, available calcium, potassium, ammonium or sodium lignosulphonates such as Reax® 88, Kraftsperse® 25S (Westvaco) and Borresperse® types (Borregard). Very particular preference is given to naphthalenesulphonate-based condensates.

The proportion of the anionic surfactants in the dispersions according to the invention (component b) can be from 0.3-3% by weight, preferably 0.3-2.5% by weight, particularly preferably 0.4-2.5% by weight.

Suitable nonionic surfactants (components c) from the group of the di- and tri-block-copolymers from alkylene oxides are, for example, compounds constructed on the bases of ethylene oxide and propylene oxide, having mean molar masses between 200 and 10000, preferably 1000 to 4000 g/mol, where the proportion by mass of the polyethoxylated block varies between 10 and 80%, such as, for example, the Synperonic® PE series (Uniqema), the Pluronic® PE series (BASF; for example Pluronic® PE 10500), VOP® 32 or Genapol® PF series (Clariant), where the products of the series mentioned are preferred. The proportion of the nonionic surfactants in the dispersions according to the invention (component c) can be 2-15% by weight, preferably 2-10% by weight, particularly preferably 2.5-8% by weight.

The components b) and c) according to the invention allow tristyrenephenol ethoxylates (TSP-EO), which are generally present both in anionic and in nonionic form, to be replaced. A typical anionic representative is Soprophor® FLK (Solvay), a typical nonionic representative is Soprophor® BSU (Solvay).

Suitable organic thickeners (components d) are organic natural or biotechnologically modified or organic synthetic thickeners. Typical synthetic thickeners are from the Rheostrux® (Croda), Thixin® or Thixatrol® series (Elementis). These are typically based on arylates. Typical organic thickeners are based on xanthan gum or cellulose or a combination thereof. Preference is given to using natural modified thickeners based on xanthan gum. Typical representatives are, for example, Rhodopol® (Solvay) and Kelzan® (Kelco Corp.), and also Satiaxane® (Cargill).

The proportion of the organic thickeners in the dispersions according to the invention (component d) can be up to 5% by weight, preferably 0.01-1.0% by weight, particularly preferably 0.01-0.6% by weight, very particularly preferably 0.05-0.5% by weight and especially preferably 0.1-0.3% by weight.

Suitable Inorganic Thickeners (Components e) are, for Example:

1) modified natural silicates such as chemically modified bentonites, hectorites, attapulgites, montmorillonites, smectites or other silicate minerals such as Bentone® (Elementis), Attagel® (Engelhard), Agsorb® (Oil-Dri Corporation) or Hectorite® (Akzo Nobel), or the Van Gel® series (R. T. Vanderbilt),

2) synthetic silicic acids and derivatives thereof, such as silicates of the Sipernat®, Aerosil® or Durosil® series (Degussa), the CAB-O-SILO series (Cabot). Preference is given to silicic acid. The proportion of the inorganic thickeners in the dispersions according to the invention (component e) can be up to 5% by weight, preferably 0.1-3% by weight, particularly preferably 0.2-1.5% by weight, very particularly preferably 0.3-1.5% by weight and especially preferably 0.4-1.3% by weight.

The specific mixture of organic thickeners d) and inorganic thickeners e) present in the following ratios to one another is likewise according to the invention:
(component d):(component e)
generally (1:300)-(10:1),
preferably (1:150)-(3:1-1.5),
particularly preferably (1:30)-(2:1-1.5),
very particularly preferably (1:15)-(1:1).

Agrochemically active compounds different from component a) (components f), which are optionally added, are suitably herbicides, fungicides, insecticides, plant growth regulators, safeners and the like. These active compounds are known, for example, from “The Pesticide Manual”, 16th Edition (2012), The British Crop Protection Council (note: index number in brackets). Preference is given to the herbicidally active compound diflufenican (272).

The proportion of agrochemically active compounds different from component a) (component f) optionally added in the dispersions according to the invention can be up to 50% by weight, preferably up to 40% by weight, particularly preferably up to 30% by weight. In the case of the herbicidally active compound diflufenican, the proportion can be 0.1-50% by weight, preferably 1-12% by weight, particularly preferably 2-10% by weight.

Further customary auxiliaries and additives which are optionally added (component g) are, for example, defoamers, antifreeze agents, structure-providing substances, preservatives, antioxidants, colourants and odourants, wetting agents, anti-drift agents, tackifiers and penetrants (adjuvants), fertilizers, and also other surfactants different from components b) and c).

Suitable defoamers are surface-active compounds based on silicone or silane such as the Tegopren® products (Goldschmidt), the SE® products (Wacker), and also the Bevaloid® and Silcolapse® products (Solvay, Dow Corning, Reliance, GE, Bayer). Preference is given to SE® (Wacker) and Rhodorsil® products (Bluestar Silicones), and particular preference is given, for example, to products such as Silcolapse® 5020.

Suitable antifreeze agents are those from the group of the ureas, diols and polyols, such as ethylene glycol and propylene glycol, preferably propylene glycol.

Suitable preservatives are, for example, products such as Acticide® MBS (Biozid, Thor Chemie). Suitable antioxidants, colourants and odourants, wetting agents, anti-drift agents, tackifiers and penetrants (adjuvants) and also fertilizers are known to the person skilled in the art. Suitable further surfactants different from components b) and c) are, for example, emulsifiers, wetting agents and dispersants.

Suitable emulsifiers, wetting agents and dispersants are, for example, nonionic emulsifiers and dispersants, for example:
1) polyalkoxylated, preferably polyethoxylated, saturated and unsaturated aliphatic alcohols,
   having 8 to 24 carbon atoms in the alkyl radical, which derives from the corresponding fatty aci1s or from petrochemical products, and
   having 1 to 100, preferably 2 to 50, ethylene oxide units (EO), where the free hydroxyl group has optionally been alkoxylated, and
   which are commercially available, for example, as Genapol® X and Genapol® O series (Clariant), Crovol® M series (Croda) or Lutensol® series (BASF);
2) polyalkoxylated, preferably polyethoxylated, hydroxy fatty acids or glycerides containing hydroxy fatty acids, for example ricinine or castor oil, having an ethoxylation level between 10 and 80, preferably 25 to 40, for example Emulsogen® EL series (Clariant) or Agnique® CSO series (BASF);
3) polyalkoxylated, preferably polyethoxylated, sorbitan esters such as, for example, Atplus® 309 F (Croda) or the Alkamuls® series (Solvay).

Preferred nonionic emulsifiers and dispersants are, for example, polyethoxylated alcohols and polyethoxylated triglycerides containing hydroxy fatty acids.

Ionic emulsifiers and dispersants are likewise suitable, for example:
1) polyalkoxylated, preferably polyethoxylated, emulsifiers/dispersants which are ionically modified, for example by conversion of the terminal free hydroxyl function of the polyethylene oxide block into a sulphate or phosphate ester (e.g. as alkali metal and alkaline earth metal salts), such as, for example, Genapol® LRO or Dispergiermittel 3618 (Clariant), Emulphor® (BASF) or Crafol® AP (Cognis);
2) alkali metal and alkaline earth metal salts of alkylarylsulphonic acids having a straight-chain or branched alkyl chain, such as phenylsulphonate CA or phenylsulphonate CAL (Clariant), Atlox® 3377BM (Croda), the Empiphos® TM series (Huntsman);
3) polyelectrolytes, such as polystyrenesulphonate or sulphonated unsaturated or aromatic polymers (polystyrenes, polybutadienes or polyterpenes)

The proportion of further customary auxiliaries and additives optionally added in the dispersions according to the invention (component g) can be up to 20% by weight, preferably up to 15% by weight.

The proportion of the component water in the dispersions according to the invention may be 20-70% by weight, preferably 20-60% by weight, particularly preferably 30-55% by weight, very particularly preferably 25-45% by weight.

The above-mentioned formulation auxiliaries of components b), c), d), e) and g) are known to the person skilled in the art and/or are described, for example, in: Watkins, “Handbook of Insecticide Dust Diluents and Carriers”, 2nd Ed., Darland Books, Caldwell N.J.; H. v. Olphen, “Introduction to Clay Colloid Chemistry”, 2nd ed., J. Wiley & Sons, N.Y.; C. Marsden, “Solvents Guide”, 2nd Ed., Interscience, N.Y. 1963; McCutcheon's “Detergents and Emulsifiers Annual”, MC Publ. Corp., Ridgewood N.J.; Sisley and Wood, “Encyclopedia of Surface Active Agents”, Chem. Publ. Co. Inc., N.Y. 1964; Schönfeldt, “Grenzflächenaktive Äthylenoxidaddukte” [Interface-active Ethylene Oxide Adducts], Wiss. Verlagsgesellschaft, Stuttgart 1976; Winnacker-Küchler, “Chemische Technologie” [Chemical Technology], Volume 7, 4th Ed., C. Hanser Verlag, Munich 1986.

For application, the dispersions according to the invention can be diluted in a customary manner, for example with water. It may be advantageous to add further agrochemically active compounds to the spray liquors obtained (for example tank mix partners in the form of appropriate formulations) and/or auxiliaries and additives used customarily, for example self-emulsifying oils such as vegetable oils or paraffin oils and/or fertilizers. The present invention therefore also provides such herbicidal compositions which can be produced based on the dispersions according to the invention.

These herbicidal compositions produced based on the dispersions according to the invention, hereinbelow also referred to as herbicidal compositions according to the invention, have excellent herbicidal activity against a broad spectrum of economically important mono- and dicotyledonous harmful plants. There is also good control over difficult-to-control perennial weeds which produce shoots from rhizomes, rootstocks or other permanent organs. The compositions may be deployed by the pre-sowing, pre-emergence or post-emergence method for example. Specific examples of some representatives of the monocotyledonous and dicotyledonous weed flora which can be controlled by the herbicidal compositions according to the invention are mentioned by way of example, though the enumeration is not intended to impose a restriction to particular species.

Examples of weed species which are controlled efficiently are, among the monocotyledonous weed species, Apera spica venti, Avena spp., Alopecurus spp. (such as, for example, Alopecurus myosuroides; syn.: black-grass, ALOMY), Brachiaria spp., Digitaria spp., Lolium spp., Echinochloa spp., Panicum spp., Phalaris spp., Poa spp., Setaria spp. and also Bromus spp. such asBromus catharticus, Bromus secalinus, Bromus erectus, Bromus tectorum and Bromus japonicus and Cyperus species from the annual group, and, among the perennial species, Agropyron, Cynodon, Imperata and Sorghum and also perennial Cyperus species.

In the case of dicotyledonous weed species, the spectrum of action extends to species such as, for example, Abutilon spp., Amaranthus spp., Chenopodium spp., Chrysanthemum spp., Galium spp. such as Galium aparine, Ipomoea spp., Kochia spp., Lamium spp., Matricaria spp., Pharbitis spp., Polygonum spp., Sida spp., Sinapis spp., Solanum spp., Stellaria spp., Veronica spp. and Viola spp., Xanthium spp., among the annuals, and Convolvulus, Cirsium, Rumex and Artemisia in the case of the perennial weeds.

The compositions according to the invention also have excellent control over unwanted plants that occur under the specific growing conditions that occur in rice, for example Echinochloa, Sagittaria, Alisma, Eleocharis, Scirpus and Cyperus.

If the herbicidal compositions according to the invention are applied to the soil surface before germination, either the emergence of the weed seedlings is prevented completely or the weeds grow until they have reached the cotyledon stage, but then they stop growing and ultimately die completely after three to four weeks have passed.

If the herbicidal compositions according to the invention are applied post-emergence to the green parts of the plants, growth likewise stops drastically a very short time after the treatment, and the weed plants remain in the growth stage at the point of time of application, or they die completely after a certain time, so that in this manner competition by the weeds, which is harmful to the crop plants, is eliminated very early and in a sustained manner.

The herbicidal compositions according to the invention are notable for a rapid onset and long duration of herbicidal action. In general, the rainfastness of the active compounds in the combinations according to the invention is favourable. A particular advantage is that the effective dosages, used in the herbicidal compositions, of herbicidal compounds can be adjusted to such a low level that the soil action thereof is optimally low. Therefore, the use thereof in sensitive crops is not just enabled, but groundwater contamination is also virtually prevented. The combination according to the invention of active compounds allows the required application rate of the active compounds to be reduced considerably. Said properties and advantages are beneficial in practical weed control in order to keep agricultural crops clear of unwanted competing plants and hence to ensure and/or increase the yields in terms of quality and quantity. These novel compositions markedly exceed the technical state of the art with a view to the properties described.

Even though the herbicidal compositions have excellent herbicidal activity against monocotyledonous and dicotyledonous weeds, there is only insignificant damage, if any, to crop plants of economically important crops, for example dicotyledonous crops such as soya, cotton, oilseed rape, sugar beet, or gramineous crops such as wheat, barley, rye, oats, millet/sorghum, rice or corn. For these reasons, the herbicidal compositions according to the invention are highly suitable for the selective control of unwanted plant growth in agriculturally useful plants or in ornamental plants.

In addition, the herbicidal compositions have excellent growth regulatory properties in crop plants. They intervene in the plants' own metabolism with regulatory effect, and can thus be used for the controlled influencing of plant constituents and to facilitate harvesting, for example by triggering desiccation and stunted growth. Furthermore, they are also suitable for the general control and inhibition of unwanted vegetative growth without killing the plants in the process. Inhibition of vegetative growth plays a major role for many mono- and dicotyledonous crops since this can, for example, reduce or completely prevent lodging.

By virtue of their herbicidal and plant growth regulatory properties, the herbicidal compositions according to the invention can also be used to control harmful plants in crops of genetically modified plants which are known or are yet to be developed. In general, the transgenic plants are characterized by particular advantageous properties, for example by resistances to certain pesticides, in particular certain herbicides, resistances to plant diseases or pathogens of plant diseases, such as certain insects or microorganisms such as fungi, bacteria or viruses. Other specific characteristics relate, for example, to the harvested material with regard to quantity, quality, storability, composition and specific constituents. For instance, there are known transgenic plants with an elevated starch content or altered starch quality, or those with a different fatty acid composition in the harvested material.

Preference is given to the use of the herbicidal compositions according to the invention in economically important transgenic crops of useful plants and ornamentals, for example of gramineous crops such as wheat, barley, rye, oats, millet/sorghum, rice and corn, or else crops of sugar beet, cotton, soya, oilseed rape, potatoes, tomatoes, peas and other vegetables. Preferably, the compositions according to the invention can be used as herbicides in crops of useful plants which are resistant, or have been made resistant by genetic engineering, to the phytotoxic effects of the herbicides.

When the herbicidal compositions according to the invention are employed in transgenic crops, not only do the effects toward harmful plants observed in other crops occur, but frequently also effects which are specific to application in the particular transgenic crop, for example an altered or specifically widened spectrum of weeds which can be controlled, altered application rates which can be used for the application, preferably good combinability with the herbicides to which the transgenic crop is resistant, and influencing of growth and yield of the transgenic crop plants.

The present invention furthermore also provides a method for controlling unwanted plant growth, preferably in crop plants such as cereals (e.g. wheat, barley, rye, oats, rice, corn, millet/sorghum), sugar beet, sugar cane, oilseed rape, cotton and soya, particularly preferably in monocotyledonous crops such as cereals, for example wheat, barley, rye, oats, crossbreeds thereof, such as triticale, rice, corn and millet/sorghum, which comprises applying one or more herbicidal compositions according to the invention to the harmful plants, plant parts, plant seeds or the area in which the plants grow, for example the area under cultivation.

The crop plants may also have been genetically modified or obtained by mutation/selection and are preferably tolerant to acetolactate synthase (ALS) inhibitors.

Preferably, the herbicidal compositions according to the invention are applied by the pre- and post-emergence method, particularly preferably by the pre-emergence method, very particularly preferably by the pre-emergence method in sown winter cereals (in an autumn application).

In addition, further particular application forms of the aqueous dispersions and herbicidal compositions according to the invention are disclosed in the claims.

The preparation of the dispersions according to the invention can take place using processes known to the person skilled in the art; for example according to Houben-Weil by wet grinding using a bead mill (see: Winnacker-Küchler, “Chemische Technologie” [Chemical Technology], Volume 7, 4th Ed., C. Hanser Verlag, München 1986; Wade van Valkenburg, “Pesticide Formulations”, Marcel Dekker, N.Y. 1973; K. Martens, “Spray Drying” Handbook, 3rd Ed., G. Goodwin Ltd., London 1979). Here, a uniform particle distribution of the active compounds in question may optionally be advantageous to additionally further prevent crystal growth and flocculation.

Examples of aqueous dispersions according to the invention can be found in the table below.

The terms used in the examples below have the following meanings:

| | |
|---|---|
| aclonifen = | common name (BSI, pa ISO); IUPAC name: 2-chloro- |
| | 6-nitro-3-phenoxyaniline (Bayer CropScience AG) |
| flufenacet = | common name (BSI, pa ISO); IUPAC name: 4′-fluoro- |
| | N-isopropyl-2-(5-trifluoromethyl-1,3,4-thiadiazol-2- |
| | yloxy)acetanilide (Bayer CropScience AG) |
| diflufenican = | common name (BSI, draft E-ISO, (m) draft F-ISO); |
| | IUPAC name: 2′,4′- difluoro-2-(α,α,α-trifluoro-m- |
| | tolyloxy)nicotinanilide (Bayer CropScience AG) |
| Morwet ® | naphthalenesulphonic acid/formaldehyde condensate, |
| D-425 = | sodium salt (Akzo Nobel) |
| Pluronic ® PE | polypropylene oxide/polyethylene oxide (PO-EO) |
| 10500 = | block polymer, nonionic (BASF) |
| TSP-EO = | surfactant group: tristyrolphenol ethoxylates |
| Soprophor ® | representative of the TSP-EO group: ethoxylated (16 |
| FLK = | EO) tristyrylphenol phosphate, potassium salt, |
| | anionic (Solvay) |
| Soprophor ® | representative of the TSP-EO group: ethoxylated (16 |
| BSU = | EO) tristyrylphenol, nonionic (Solvay) |
| Rhodopol ® G = | xanthan derivative, organic thickener (Solvay) |
| Aerosil ® 200 = | pyrogenic silicic acid, inorganic thickener (Evonik) |
| citric acid = | polybasic organic acid |
| Silcolapse ® | silicone defoamer (Bluestar Silicones) |
| 411 = | |
| glycerol = | antifreeze agent |
| Proxel ® GXL = | preservative (Biozid, Arch) |

1. Preparation of the Aqueous Dispersions

To prepare the examples mentioned in Table 1, water is initially charged. With stirring, aclonifen and flufenacet (component a) (and optionally further active compounds (component f)) and the further components b), c), e) and g) are subsequently added (in no particular order). The mixture is then subjected to wet grinding, for example in a bead mill. Finally, the organic thickener (component d) is added.

TABLE 1
Compositions (stated in percent by weight; % by weight)

| | | Examples according to the invention | | | | | | | Comparative examples ¹⁾ | | |
|---|---|---|---|---|---|---|---|---|---|---|---|
| Component | | 1 | 2 | 3 | 4 | 5 | 6 | 7 | C1 | C2 | C3 |
| a | aclonifen | 37 | 37 | 37 | 37 | 31 | 21 | 33.3 | 37 | 37 | 37 |
| a | flufenacet | 12 | 9.8 | 6.1 | 7.4 | 8.2 | 12.8 | 13.3 | 9.8 | 9.8 | 9.8 |
| f | diflufenican | — | 2.45 | 4.9 | 2.45 | 9.8 | 4.4 | 6.6 | 2.45 | 2.45 | 2.45 |
| b | Morwet ® D-425 | 1 | 1 | 1 | 1 | 1 | 1 | 1 | 1 | 1 | 1 |
| c | Pluronic ® PE | 5 | 5 | 5 | 5 | 5 | 5 | 5 | — | 5 | 5 |
| | 10500 | | | | | | | | | | |
| — | Soprophor ® FLK | — | — | — | — | — | — | — | 2 | — | — |
| — | Soprohor ® BSU | — | — | — | — | — | — | — | 3 | — | — |
| d | Rhodopol ® G | 0.2 | 0.2 | 0.2 | 0.2 | 0.2 | 0.2 | 0.2 | 0.2 | 0.2 | — |
| e | Aerosil ® 200 | 1 | 1 | 1 | 1 | 1 | 1 | 1 | 1 | — | 1 |
| g | citric acid | 0.2 | 0.2 | 0.2 | 0.2 | 0.2 | 0.2 | 0.2 | 0.2 | 0.2 | 0.2 |
| g | Silcolapse ® 411 | 0.5 | 0.5 | 0.5 | 0.5 | 0.5 | 0.5 | 0.5 | 0.5 | 0.5 | 0.5 |
| g | glycerol | 5 | 5 | 5 | 5 | 5 | 5 | 5 | 5 | 5 | 5 |
| g | Proxel ® GXL | 0.2 | 0.2 | 0.2 | 0.2 | 0.2 | 0.2 | 0.2 | 0.2 | 0.2 | 0.2 |

| | | | | | | | | | | |
|---|---|---|---|---|---|---|---|---|---|---|
| Water | 37.9 | 37.65 | 38.9 | 40.05 | 37.9 | 48.7 | 33.7 | 37.9 | 38.65 | 37.85 |
| density in g/ml | 1.22 | 1.22 | 1.22 | 1.22 | 1.22 | 1.17 | 1.23 | 1.22 | 1.22 | 1.22 |
| total: | 100 | 100 | 100 | 100 | 100 | 100 | 100 | 100 | 100 | 100 |

¹⁾ Explanation of the comparative examples:
C1 = modified formulation based on commercial Bandur 600 SC formulation comprising TSP-EO and components d) and e) - the modification comprises in each case the addition of components a) or f) with regard to better comparability with the examples according to the invention;
C2 + C3 = formulations without the specific thickener combination of components d) and e) - analogous to the composition of Example 2 according to the invention.

2. Storage Stability and Further Formulation Properties of the Aqueous Dispersions

The dispersions of Examples 1 to 7 according to the invention have excellent storage stability. At room temperature, they are stable for at least 2 years, and at 40° C. for at least 3 months, without any negative changes. Table 2 compares the examples according to the invention with the non-inventive comparative examples from Table 1.

Method: All tests were carried out by CIPAC methods customary in crop protection (CIPAC=Collaborative International Pesticides Analytical Council; www.cipac.org). Long-term storage was carried out according to CIPAC MT 46.3 at 8 weeks 40° C. storage time. The terms used below have the following meanings:
0TW=test result after zero days of storage.
8W40=test result of the accelerated storage test (8 weeks 40° C.) for examining the long-term stability of a formulation product.
suspendability=active compound distribution in a 1% aqueous solution (100%=completely homogeneous distribution, 0%=complete sedimentation);
suspendability 8W40=active compound distribution after storage test (8 weeks 40° C.); values <100% lead to heterogeneous product distribution after application; according to international requirements, formulation products must have values >60% D90=active compound particle size (laser scattering 90% of all volume particles).
D90 8W40=active compound particle size after storage test (8 weeks 40° C.); increased values point to crystal growth, with increases by a factor of 2 being considered to be acceptable, whereas increases by a factor of 4 are no longer acceptable sediment=values >10% characterize strong sediment formation.
sediment can be shaken up=yes for acceptable; no for unusable formulation products, since the active compounds can no longer be converted into a spray liquor.
wet screening=measure for possible blocked filters during spray application; values >0.1% on 150 μm screen and >0.2% on 45 μm screen (in each case based on the amount of formulation employed) are not acceptable.

TABLE 2
Storage stability and further formulation properties - Comparison
of Example 2 (in accordance with the invention) with Comparative
examples C1-C3 (not in accordance with the invention)

| | | | Comparative examples | | | |
|---|---|---|---|---|---|---|
| | CIPAC | Example | | | | observation −> |
| Test method | test norm | 2 | C1 | C2 | C3 | comment |
| suspendability | MT 184 | 88% | 85% | 88% | 88% | |
| 0TW | | | | | | |
| suspendability | MT 184 | 73% | <60% | <60% | <60% | does not meet |
| 8W40 | | | | | | requirements |
| D90 | MT 187 | 7 μm | 7 μm | 7 μm | 7 μm | |
| 0TW | | | | | | |
| D90 | MT 187 | 17 μm | 43 μm | 21 μm | 52 μm | crystal growth |
| 8W40 | | | | | | |
| sediment | MT 148 | 4% | 31% | 46% | 87% | formation of |
| 8W40 | | | | | | sediment |
| sediment can be | MT 148 | yes | no | no | no | not usable |
| shaken up, 8W40 | | | | | | |
| wet screening | MT 185 | 0.05% | 0.5% | 0.4% | 1.5% | sediment |
| 45 μm | | | | | | formation −> |
| 8W40 | | | | | | blocked filter |
| wet screening | MT 185 | 0.01 | 0.05% | 0.05% | 0.1% | sediment |
| 150 μm | | | | | | formation −> |
| 8W40 | | | | | | blocked filter |

Comment: Storage stability tests showed that only Example 2 (which comprises the thickener mixture according to the invention of component d), here Rhodopol ® G, and component e), here Aerosil ® 200, combined with active compound mixture a) or f), component b), here Morwet ® D-425, and component c), here Pluronic ® PE 10500), has the desired formulation properties such as storage stability.
The non-inventive Comparative Example C1 (which comprises TSP-EO) is not storage-stable and shows crystal growth. Comparative Examples C2 and C3 (without thickener mixture according to the invention) show a strong sediment formation which leads to unusable formulations. The Examples 1, 3 to 7 according to the invention from Table 1 have the same desired formulation properties as Example 2.

3. Herbicidal Activity of the Aqueous Dispersions

Method: Standard autumn field application of 200 1/ha spray liquors at a dosage of 600 g of aclonifen, 240 g of flufenacet and 120 g of diflufenican per hectare. What was evaluated was the herbicidal activity with respect to black-grass (Alopecurus myosuroides; ALOMY) and the phytotoxicity with respect to the crop plants winter barley and winter wheat; evaluated visually on a scale of 0-100% in comparison to an untreated comparative group: 0%=no noticable effect compared to the untreated comparative group; 100%=full effect compared to the untreated comparative group.

TABLE 3
Comparative test: (tank mix vs. co-formulation)

| | | Herbicidal | | |
|---|---|---|---|---|
| | | activity with | Phytotoxicity in . . . | |
| Application | | respect to | winter | winter |
| form | Products ¹⁾ | ALOMY | barley | wheat |
| tank solo | Bandur | 28% | 2% | 1% |
| tank mix | Brodal + | 83% | 8% | 2% |
| | Cadou | | | |
| | Bandur + | 88% | 18% | 5% |
| | Cadou + | | | |
| | Brodal | | | |
| co-formulation | Table 1: Example 7 | 92% | 12% | 2% |
| | (according to the | | | |
| | invention) | | | |

¹⁾ commercial products used
Bandur = Bandur 600 SC formulation comprising 600 g/l of aclonifen (50% by weight) and TSP-EO (Bayer CropScience AG)
Cadou = Cadou 508 SC formulation comprising 508 g/l of flufenacet (42% by weight) and component c): Pluronic PE 10500 (Bayer CropScience AG)
Brodal = Brodal 500 SC formulation comprising 500 g/l of diflufenican (42% by weight) and TSP-EO (Bayer CropScience AG)

Comment: The co-formulation according to the invention comprising the herbicidally active compounds (Example 7) without any TSP-EO did not only show higher herbicidal activity than the comparable tank mix (92% vs. 88%) but also leads to lower phytotoxicity in the crop plants winter barley (12% vs. 18%) and winter wheat (2% vs. 5%).

This comparative test shows that the co-formulation according to the invention of the herbicidally active compounds is more advantageous than the corresponding tank mix of the active compounds formulated individually.

1. Aqueous dispersion, comprising
a) the herbicidally active compounds aclonifen and flufenacet,
b) one or more anionic surfactants from the group of the sulphonates, selected from the groups based on naphthalenes, the alkylaryl, the fused naphthalenes and based on lignin,
c) one or more nonionic surfactants from the group of the di- and tri-block-copolymers of alkylene oxides,
d) an organic thickener based on xanthan gum,
e) an inorganic thickener,
f) optionally one or more agrochemically active compounds different from component a), g) optionally one or more further customary auxiliaries and additives,
and
water;
where the components d) and e) are in specific mixing ratios to one another.

2. Dispersion according to claim 1, comprising
a) 20 to 45% aclonifen and 4 to 20% flufenacet, at a total amount of 24 to 65%,
b) 0.3 to 3% of one or more anionic surfactants from the group of the sulphonates, selected from the groups based on naphthalenes, the alkylaryl, the fused naphthalenes and based on lignin,
c) 2 to 15% of one or more nonionic surfactants from the group of the di- and tri-block-copolymers of alkylene oxides,
d) 0.01 to 1% of an organic thickener based on xanthan gum,
e) 0.1 to 3% of an inorganic thickener,
f) 0 to 50% of one or more agrochemically active compounds different from component a), g) 0 to 20% of one or more further customary auxiliaries and additives,
and
20 to 70% water;
where the components d) and e) are present in a ratio of from 1:300 to 10:1 to one another.

3. Dispersion according to claim 1, comprising
a) 20 to 45% aclonifen and 4 to 20% flufenacet,
b) 0.3 to 3% of one or more anionic surfactants from the group of the naphthalene sulphonates, alkylarylsulphonates or lignosulfonates, and from the group of the condensates of naphthalenesulphonates with formaldehyde,
c) 2 to 10% of one or more nonionic surfactants from the group of the di- and tri-block-copolymers of alkylene oxides,
d) 0.05 to 0.5% of an organic thickener based on xanthan gum,
e) 0.3 to 1.5% of an inorganic thickener,
f) 0 to 50% of one or more agrochemically active compounds different from component a),
g) 0 to 20% of one or more further customary auxiliaries and additives,
and
20 to 70% water;
where the components d) and e) are present in a ratio of from 1:30 to 2:1-1.5 to one another.

4. Dispersion according to claim 1, comprising
a) 24 to 39% aclonifen and 6 to 14% flufenacet,
b) 0.4 to 2.5% of one or more anionic surfactants from the group of the naphthalene sulphonates, alkylarylsulphonates or lignosulfonates, and from the group of the condensates of naphthalenesulphonates with formaldehyde,
c) 2.5 to 8% of one or more nonionic surfactants from the group of the di- and tri-block-copolymers of alkylene oxides,
d) 0.1 to 0.3% of an organic thickener based on xanthan gum,
e) 0.4 to 1.3% of an inorganic thickener,
f) 0 to 50% of one or more agrochemically active compounds different from component a),
g) 0 to 20% of one or more further customary auxiliaries and additives,
and
25 to 70% water;
where the components d) and e) are present in a ratio of from 1:15 to 1:1 to one another.

5. Dispersion according to claim 1, where the agrochemically active compound different from a) is diflufenican (component f).

6. Dispersion according to claim 1, additionally comprising one or more further customary auxiliaries and additives (component g) optionally defoamers, antifreeze agents, structure-providing substances, preservatives, antioxidants, colourants and odourants, wetting agents, anti-drift agents, tackifiers and penetrants (adjuvants) and fertilizers.

7. Process for preparing an aqueous dispersion according to claim 1 which comprises mixing and then grinding components a), b), c), e), g) and optionally f) and finally adding component d).

8. Method for controlling unwanted vegetation, which comprises applying an effective amount of an aqueous dispersion according to claim 1 to plants, parts of plants, seed or an area on which plants grow.

9. A product comprising an aqueous dispersion according to claim 1 for controlling unwanted vegetation.

10. A product comprising an aqueous dispersion according to claim 1 for producing a herbicidal composition.

11. A product according to claim 10, where the herbicidal composition is a suspension or suspoemulsion.

12. Liquid herbicidal composition, obtainable by diluting an aqueous dispersion according to claim 1.

13. Liquid herbicidal composition according to claim 12, where the herbicidal composition is an emulsion, a suspension, a suspoemulsion or a solution.

14. Liquid herbicidal composition according to claim 12, comprising
a) the herbicidally active compounds aclonifen and flufenacet,
b) one or more anionic surfactants from the group of the sulphonates, selected from the groups based on naphthalenes, the alkylaryl, the fused naphthalenes and based on lignin,
c) one or more nonionic surfactants from the group of the di- and tri-block-copolymers of alkylene oxides,
d) an organic thickener based on xanthan gum,
e) an inorganic thickener,
and
water;
where the components d) and e) are in specific mixing ratios to one another.

15. Liquid herbicidal composition according to claim 14, additionally comprising
f) one or more agrochemically active compounds different from component a),
g) one or more further customary auxiliaries and additives.

16. Liquid herbicidal composition according to claim 15, where the agrochemically active compound different from component a) is diflufenican.

17. Method for controlling unwanted vegetation, which comprises applying an effective amount of a herbicidal composition according to claim 12 to plants, parts of plants, seed or an area on which plants grow.

18. A product comprising a herbicidal composition according to claim 12 for controlling unwanted vegetation.

19. A product comprising a herbicidal composition according to claim 12 for controlling unwanted vegetation by a pre-emergence method and post-emergence method.
